(19) United States
(12) Patent Application Publication
(10) Pub. No.: US 2019/0025578 A1
(43) Pub. Date: Jan. 24, 2019

(54) APPARATUS FOR DISPLAYING THREE-DIMENSIONAL IMAGES AND VIDEOS IN REAL ENVIRONMENTS

(71) Applicant: MDH HOLOGRAM S.A., Luxembourg (LU)

(72) Inventor: Giuseppe BOFFI, Giussano (IT)

(21) Appl. No.: 16/070,119

(22) PCT Filed: Jan. 13, 2017
(86) PCT No.: PCT/EP2017/050701

§ 371 Date: Jul. 13, 2018

(30) Foreign Application Priority Data
Jan. 15, 2016 (LU) LU 92949

(51) Int. Cl. G02B 27/01; G06T 19/00

(52) U.S. Cl. CPC G02B 27/0101; H04R 1/028; G06T 19/006

(57) ABSTRACT

An apparatus (10, 10′) for displaying three-dimensional images and videos in real environments, comprising a supporting structure (12), at least one real environment (14, 14′), a reflection environment (20, 20′) a reflecting transparent screen (30, 30′) disposed vertically along a plane identified by the diagonal of the aforesaid reflection environment (20, 20′) and subsequently comprising a video surface (40) which entirely or partially defines a vertical side of the aforesaid reflection environment (20), the aforesaid vertical side being adjacent to the open side leading to the aforesaid real environment (14, 14′).

This invention refers to an “Apparatus for the display of three-dimensional images and videos in real environments”.

More specifically, the invention concerns an apparatus for the display of three-dimensional hologram-type images and videos in real environments such as stages, exhibit stands, store windows, commercial centers, marketing exhibits, etc.

In the entertainment, show business and publicity sectors, apparatuses are known that use the technique of projecting a moving image, which takes place in an environment that is not possible to directly observe on a transparent screen, partially reflecting and inclined in such manner as to create, in the observer, the illusion of seeing the moving image projected three-dimensionally as though it was actually present in reality, an illusion normally called Pepper's ghost. The transparent, reflecting screen is generally arranged with a 45° angle relative to the direction of the observer and in general comprises a film of polymeric material, conveniently placed in tension by a means of tension affixed to a bearing structure. The abovementioned transparent and reflecting screen is arranged between the directly observable environment, typically a stage, and the spectator, in such manner as to reflect the image that is occurring in an environment that is not directly visible by the spectator. The image, which takes place in an environment which is not directly visible, may also be a video image projected onto a screen through the use of a projector.

Some examples of embodiment of systems and methods for generating, through the observer, the illusion of a virtual image, or Pepper's ghost, are described in European patents EP 1 733 279 B1, EP 2 141 540 B1 and EP 222 990 B1 concerning an image projection device comprising a stage, a bearing structure, a video projector stabilized according to the said bearing structure, a projection screen onto which is projected the video image, and a partially transparent and reflecting screen. The bearing structure supports the projection screen and the transparent screen in tension in such manner that the same ones are inclined at an angle that is determined relative to the plane in which the light from the video projector is emitted. The transparent screen has an anterior surface that is arranged so that the light emitted by the projector is reflected in the direction of the observer and so that this latter has the illusion that the projected video image appear to be taking place on the stage.

The abovementioned projection apparatuses or systems nevertheless present drawbacks and functional limitations.

One functional limitation of these known projection apparatuses or systems is due to the fact that they have dimensions and footprints that are especially large, which makes them useable only in large-size environments, with a ceiling height that is greater than normal locations intended for civil and commercial use. Another limitation of these projection apparatuses or systems is due to the fact that, in order to generate a three-dimensional or holographic illusion, it is necessary to project or reproduce the video image to be reflected onto a plane that is arranged at a height that is different relative to the stage and outside of the visual field of the spectator, a condition that requires an apparatus with a depth dimension that is particularly high in the direction of the observer. This characteristic limits the use of the projection apparatus to locations or environments where it is possible to use two levels at different heights and with an especially high depth dimension.

Another limitation of these known projection apparatuses or systems is due to the fact of being able to reproduce the holographic illusion exclusively on the stage alone, without the possibility of having available a scenography or an alternative scenic environment.

The purpose of the present invention is to remedy the abovementioned limitations.

More specifically, the object of the present invention is to provide an apparatus for the display of three-dimensional images and videos in real environments that can be easily adapted to environments intended for civil or commercial use, and which have reduced dimensions and depth.

Another object of the present invention consists of making available to the user an apparatus for the display of three-dimensional images and videos in real environments, which may easily be arranged in environments or locations in stores, publicity stands, boutiques, studios, theaters and cinemas and similar, and use these same as real scenography on which to display a three-dimensional or holographic video image.

An further object of the present invention is that of making available to users an apparatus for the display of three-dimensional images and videos in real environments capable of using numerous scenographic environments.

Yet another object of the present invention is that of making available to users an apparatus for the display of three-dimensional videos and images in real environments, that is capable of assuring a high level of resistance and reliability over time and, moreover, such that it can be produced easily and economically.

The abovementioned objects and still others are achieved by an apparatus for the display three-dimensional images and videos in real environments, comprising a bearing structure and comprising at least one real environment; a reflection environment, a transparent, reflecting screen, arranged vertically along a plane that is identified by the diagonal of the said reflection environment; and characterized in that it comprises a video surface that entirely or partially defines one vertical side of the said reflection environment, with the abovementioned vertical side being adjacent to the open side that gives out onto the abovementioned real environment.

According to an advantageous embodiment of the invention, the abovementioned structure comprises structural components that are stabilized between each other in a mobile manner and is bounded above and below respectively by a ceiling and a floor.

According to an advantageous embodiment of the invention, the abovementioned real environment defining a place or a room is bounded along the perimeter and on at least three sides by vertical surfaces.

According to an advantageous embodiment of the invention, the abovementioned reflection environment (20) defining an area or a room, is bounded laterally over one portion or one side by at least one vertical surface, and defines one portion of open perimetric surface or one transparent side, the abovementioned reflection environment being contiguous to the said real environment, and the abovementioned reflection environment and real environment being open to view and connecting in correspondence with the respective tilted portions or sides.

According to an advantageous embodiment of the invention, the abovementioned vertical surfaces of the abovementioned real environment and reflection environment includes partitions, rigid panels, curtains, cloths or equivalents.

According to an advantageous embodiment of the invention, the said transparent screen is made of a vitreous material, Plexiglas or other rigid and transparent material.

According to an advantageous embodiment of the invention, the said transparent screen is a sheet or MYLAR-type film made of polymeric material that is flexible and held in tension.

According to an advantageous embodiment of the invention, the said video surface comprises at least one flat digital TV video screen or a multitude of video modules 41 that are very thin, of the type used for LCD, PDP, LED, OLED screens, retro-projected panels.

According to an advantageous, the said TV video screen and the said digital video modules 41 are of the stereoscopic or 3D type.

According to an advantageous embodiment of the invention, the apparatus comprises means of direct or diffused illumination of the said real environment.

According to an advantageous embodiment of the invention, the apparatus comprises loudspeakers arranged in correspondence with the said transparent side of the reflection environment.

According to an advantageous embodiment of the invention, the abovementioned real environment is produced to scale relative to real proportions.

According to an advantageous embodiment of the invention, the apparatus comprises a second real environment in visual communication with the abovementioned projection environment (20) in the position opposite to the first real environment.

According to an advantageous embodiment of the invention, the abovementioned transparent screen is provided with a means of movement, including rotating pins and a means of blockage.

According to an advantageous embodiment of the invention, the abovementioned transparent screen is provided with a means of movement, comprising sliding guides of the vertical edges of the same transparent screen, that are capable of arranging the abovementioned vertical edges on the tops that are opposite to the said projection environment.

The constructive and functional characteristics of the apparatus for the display of three-dimensional images and videos in real environments according to the present invention may be better understood by the detailed description that follows, in which reference is made to the attached drawings, which represent one preferred, non-limiting form of embodiment, in which:

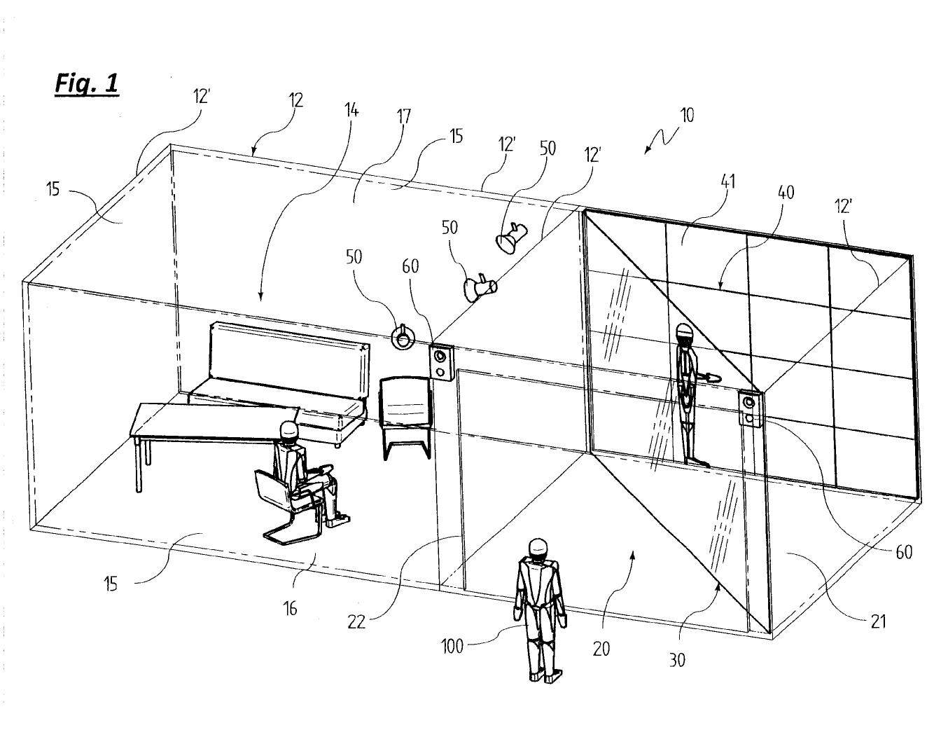

FIG. 1 is an axonometric, schematic, semi-transparent representation of the apparatus for the display of three-dimensional images and videos in real environments according to the present invention;

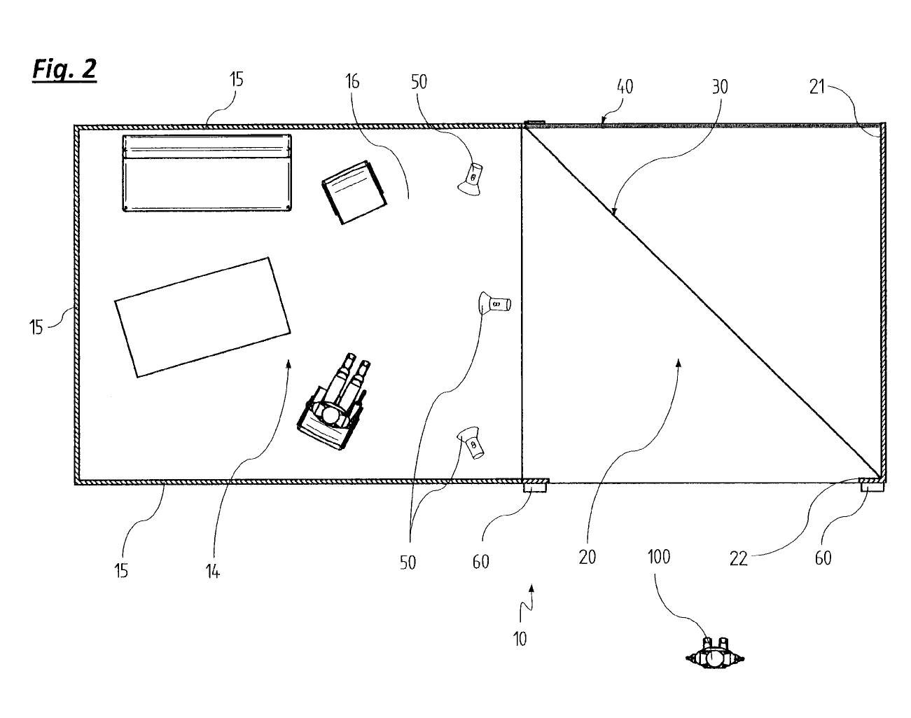

FIG. 2 is a schematic, section representation of the plane of the apparatus for the display of three-dimensional images and videos in real environments subject of the invention;

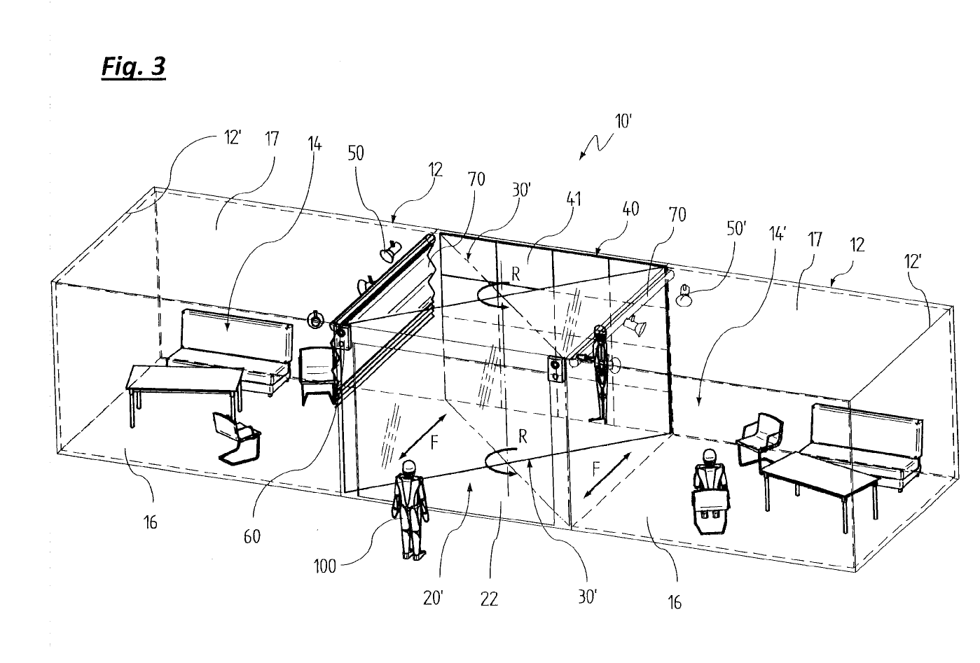

FIG. 3 is a schematic perspective and semi-transparent representation of the apparatus for the display of three-dimensional images and videos in real environments according to the invention with two real environments;

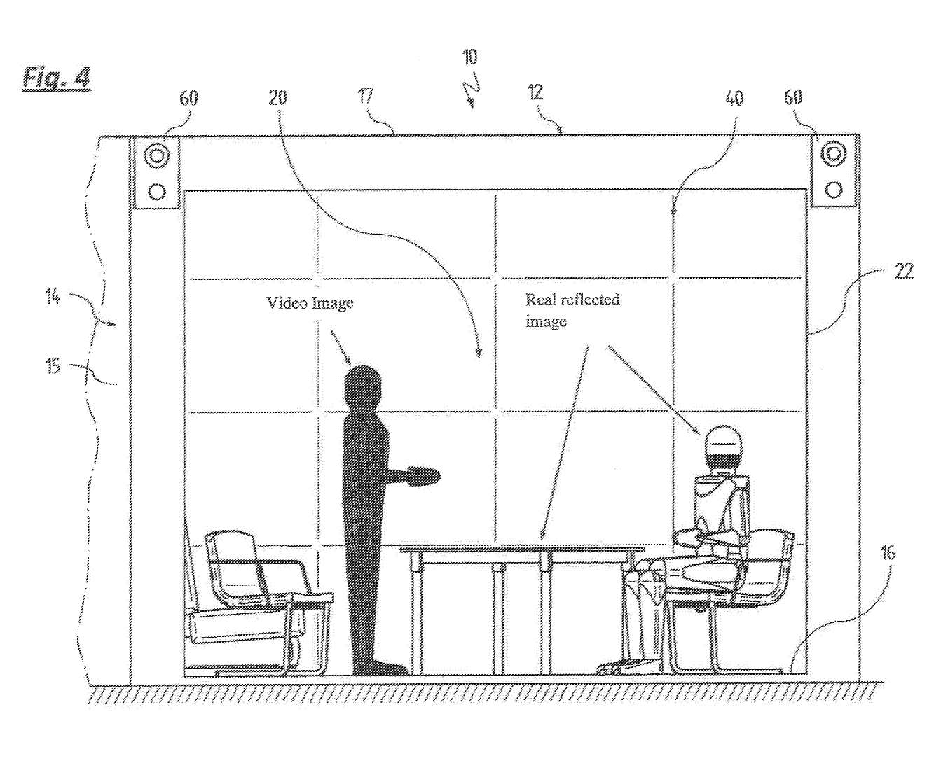

FIG. 4 is a schematic perspective representation of the apparatus for the display of three-dimensional images and videos in real environments subject of the invention depending on the visual direction of the observer.

Referring initially to FIGS. 1 and 2, the apparatus for the display of three-dimensional images and videos in real environments according to the invention, in a principal manner of embodiment indicated in the figures with reference 10, comprises a bearing structure 12 that is provided with structural components 12′ reciprocally stabilized in a mobile manner and bounded, either above or below, respectively, by a ceiling 17 and a floor 16. The abovementioned structure 12 may also be advantageously defined by the horizontal and vertical surfaces of the building or of the environment inside of which the apparatus 10 is arranged, or be directly integrated into these same surfaces.

Apparatus 10 additionally includes:
at least one real environment 14 that defines an area or a room and is bounded along its perimeter and on at least three sides by vertical surfaces 15 which may be partitions, rigid panels, curtains, cloth or equivalents;
a reflection environment 20 defining an area or a room and laterally bounded, on one portion or side, by at least one vertical surface 21, of a partition, rigid panel, curtain, cloth type or equivalent, defining an open portion of perimetric surface or a side 22 that is transparent to light, in the direction of an observer 100, with the abovementioned reflection environment 20 being contiguous to the said real environment 14, in such manner that the abovementioned reflection environment 20 and real environment 14 are open to view and communicate in correspondence with the portions or sides;
a transparent screen 30, reflecting or partially reflecting light, made of a vitreous material, Plexiglas or another rigid and transparent material or of a sheet, a MYLAR type film made of polymeric material (for example PC, PE, PET), flexible and ideally in tension, with the said transparent screen 30 being arranged vertically along a plane identified by the diagonal of the abovementioned reflection environment 20 in such manner as to reflect the light coming from the real environment 14 towards the direction of observer 100;
a video surface 40 including at least one digital TV video screen, advantageously flat and with a reduced thickness, of the type of well known screens LCD, PDP, LED, OLED retro-projected panels or equivalent, where the abovementioned video surface 40 may be advantageously arranged in such manner as to define or entirely cover either [sic] only a portion of surface, a vertical side of the said reflection environment 20, the abovementioned vertical side being adjacent to the open side that gives out onto the abovementioned real environment 14.

Apparatus 10 for the display of three-dimensional images and videos in real environments can be further provided with:
means of illumination 50 either direct or diffused, capable of integrally illuminating the abovementioned real environment 14, in the entirety of the volume of the said real environment 14, or according to a partial and localized embodiment; loudspeakers 60 for propagating voices, sounds and melodies in the direction of the observer 100, with the said loudspeakers 60 being arranged in correspondence with the said transparent side 22 in such manner as to propagate the sound in the direction of the said observer 100.

The abovementioned transparent screen 30 preferably comprises a crystal glass plate of the semi-transparent type, with a ratio of 70/30 between transmission and reflection of light at low chromatic influence and which may, moreover, be provided with an interferential optical coating on one or both sides, in order to transmit and reflect the image according to a specified light proportion.

According to one alternative embodiment, the abovementioned video surface 40 may advantageously comprise a plurality of flat video modules 41, of type LCD, PDP, LED, OLED, retro-projected or equivalent screens, arranged in a matrix and cooperating to form a unique video support (maxi screens, watt video, multi-screen), in such manner as to also cover large surfaces. The abovementioned TV video screens or digital video modules may also be advantageously of the stereoscopic or 3D type.

In a constructive variation, the abovementioned real environment may be made with smaller dimensions and according to a specified scale, with a visual perspective such that its image results from real proportions once reflected towards observer 100.

Referring to FIG. 3, according to a different embodiment the apparatus 10′ for the display of three-dimensional images and videos in real environments comprises an alternative second real environment 14′ arranged in visual communication with a projection environment 20′ arranged in a position that is substantially opposed to the first real environment 14. In this embodiment, the transparent screen 30′ is provided with a means of movement in such manner as to selectively and alternatively reflect the light emanating from the real environment 14 or from the real environment 14′. In the case where the abovementioned transparent screen 30 comprises a rigid support, the means of movement may comprise rotation pins as well as means of blockage that make it possible for the screen itself to rotate about its vertical axis, according to arrow R and to arrange itself, inside of the abovementioned reflection environment 20′, according to a configuration that is opposite the starting one. In the case where the said transparent screen is made of a flexible support, of the sheet or MYLAR type, where the abovementioned means of rotation may comprise translation or sliding guides that are capable of leading the respective vertical edges of the same transparent screen 30′ to move or slide according to the direction of arrows F, along the horizontal edges of the portions of the surfaces or sides in visual communication with the abovementioned real environments 14, 14′, in such manner as to arrange the abovementioned vertical edges on opposite vertices from the said reflection environment 20′. The abovementioned real environments 14, 14′ may also be visually separated from the reflection chamber by curtains or barriers 70.

In a further embodiment, the transparent screen 30 may be folded into two halves, for example to form an angle with the top arranged in the direction of observer 100, in such manner as to make it possible to simultaneously reflect the image of the first and of the second real environment 14, 14′

By the description of the parts that constitute apparatus 10, 10′ for the display of three-dimensional images and videos in real environments according to this invention, we deduce the operation of this apparatus, which is described below.

By referring to FIGS. 1, 2 and 3, the apparatus for the display of three-dimensional images and videos in real environments is arranged inside, or preferably directly integrated into, real environments or places intended for a civil usage such as areas or shopping halls, publicity or exhibit stands, stores, workshops, auditoriums, theater or cinematographic stages and similar.

In effect, the real environment 14 may be advantageously defined by a real place where a real action occurs or instead of a position with two individuals or real objects. This real environment 14, when it is illuminated at the right time, is not directly visible by the observer 100 because it is open only in the direction of the perimetric part that communicates visually with the abovementioned reflection environment 20. Referring in particular to FIG. 4, the observer 100, while looking in the direction of, and through, the open portion of the transparent side 22 of the said reflection environment 20, which may be defined by a store window, sees a mirror image of the said real environment 14 reflected perpendicularly towards the observer himself by the transparent screen 30, which is partly reflective. To this reflected image is added, by visual cooperation, the image emitted by the video surface 40 arranged frontally relative to the observer 100, with the abovementioned image being visualized directly by the observer through the transparent screen 30. This video image may moreover be appropriately calibrated with known video development systems, in such manner as to appear like a particular place in the space of the said real environment 14. In this way, observer 100 perceives the image emanating from the video surface 40 as though it was really there and as though it was really part of the real environment 14, by generating, in the observer him/herself, the three-dimensional visual illusion of an image that is otherwise two-dimensional, which also includes audio perception of the stage, provided by the loudspeakers 60.

According to the alternative embodiment of apparatus 10′, the transparent screen 30′ is advantageously mobile and may be configured in such manner as to selectively reflect, towards operator 100, the image emanating from multiple environments 14 or 14′, alternatively and opportunely illuminated by the means of illumination 50, 50′. The portions or sides of the said real environments 14, 14′, which are tilted and which are in visual communication with the said reflection environment, may be closed or separated by curtains or barriers 70, in order to alternatively insulate these environments from view, in such manner that the light emanating from one of them does not disturb the image reflected by the other.

As can be seen from the above, the advantages obtained by apparatus 10 for the display of three-dimensional images and videos in real environments subject of the present invention are obvious.

The apparatus 10 for the display of three-dimensional images and videos in real environments of the present invention result in being particularly advantageous due to having a substantially direct dimensional developing width relative to the observer 100, in such manner as to make it possible to reduce the depth dimensions, thanks also to the use of a video surface 40 formed by flat TV video screens, a characteristic that makes it also advantageously useable in places with low ceilings and with windows, doors, etc.

A further advantage of the apparatus 10 for the display of three-dimensional images and videos in real environments of the present invention is shown by the fact that it is possible, thanks to modern video screens, to arrange a raised video reproduction surface, which has moreover a reduced background luminosity (black screen) which improves vision, on the part of the user, of the reflected image of the real environment 14, 14′.

Another advantage of apparatus 10 for the display of three-dimensional images and videos in real environments of the present invention is the ability to arrange numerous real environments to which may be associated a virtual video image which creates, in the observer, the illusion that it is occurring in a real environment.

Although the invention has been described by referring in particular to its preferred embodiments, which are given exclusively as examples and are not limiting, numerous modifications and variations of the abovementioned description will become apparent to a technician in the lighting sector. The present invention, consequently, is expected to cover all modifications and variations that are within the spirit and scope of the following claims.

1. An apparatus for the display of three-dimensional images and videos in real environments, comprising a bearing structure and comprising:
at least one real environment;
a reflection environment;
a transparent and reflecting screen, arranged vertically along a plane identified by the diagonal of the said reflecting environment;
a video surface defining, entirely or partially, a vertical side of the said reflection environment, with the said vertical side being adjacent to the open side that gives out onto the abovernentioned real environment;
wherein the apparatus is configured in such manner that an observer looking in the direction of the transparent and reflecting screen may see a reflected image of the real environment and a transmitted image of the video surface.

2. The apparatus according to claim 1, wherein the abovementioned structure comprises structural components stabilized between themselves in a mobile manner and is bounded above and below respectively by a ceiling and a floor.

3. The apparatus according to claim 1, wherein the abovementioned real environment defining an area or a room is bounded along the perimeter and on at least three sides by vertical surfaces.

4. The apparatus according to claim 1, wherein the real environment is not directly visible by the observer.

5. The apparatus according to claim 1, wherein the abovementioned reflective environment defining an area or a room, is bounded laterally over a portion or a side by at least one vertical surface, and defines a portion of open perimetric surface or with a transparent side, the abovementioned reflection environment being contiguous to the abovementioned real environment, and the abovementioned reflection environment and real environment communicating visually through the portion of open perimetric surface or the transparent side.

6. The apparatus according to claim 3, wherein the abovementioned vertical surfaces of the abovementioned real environment and reflection environment comprise partitions, rigid panels, curtains, cloths or equivalent,

7. The apparatus according to claim 1, wherein the said transparent screen is made using a vitreous material, Plexiglas or other rigid, transparent material.

8. The apparatus according to claim 7, wherein the said transparent screen is a sheet or a MYLAR type film of polymeric material, flexible and placed under tension.

9. The apparatus according to claim 1, wherein the said video surface comprises at least one flat digital TV video screen or a multitude of video modules 41 having a very low thickness, of screen types LCD, PDP, LED, OLED, retro-projected panels.

10. The apparatus according to claim 9, wherein the said TV video screen and the said digital video modules 41 are of the stereoscopic or 3D type.

11. The apparatus according to claim 1, wherein it comprises of direct or diffused means of illumination of the said real environment.

12. The apparatus according to claim 1, wherein it comprises loudspeakers arranged in correspondence with the said transparent side of the reflection environment.

13. The apparatus according to claim 11, wherein the abovementioned real environment is made to scale relative to the real proportions.

14. The apparatus according to claim 1, wherein it comprises a second real environment arranged in visual communication with the abovementioned projection environment in the opposite position relative to the first real environment.

15. The apparatus according to claim 1, wherein the abovementioned transparent screen is provided with a means of movement, comprising rotating pins and means of blockage.

16. The apparatus according to claim 15, wherein the abovementioned transparent screen is provided with a means of movement, comprising sliding guides for the vertical edges of the same transparent screen, that are capable of arranging the abovementioned vertical edges on the tops opposite of the said projection environment.

17. The apparatus according to claim 5, wherein the abovementioned vertical surfaces (15, 21) of the abovementioned real environment and reflection environment comprise partitions, rigid panels, curtains, cloths or equivalent.
